(19) United States
(12) Patent Application Publication
(10) Pub. No.: US 2008/0130592 A1
(43) Pub. Date: Jun. 5, 2008

(54) APPARATUS AND METHOD FOR MANAGING MEDIUM ACCESS SLOT IN WIRELESS PERSONAL AREA NETWORK

(75) Inventors: Sangjae Lee, Daejon (KR); Young-Ae Jeon, Daejon (KR); Sangsung Choi, Daejon (KR); Kwang-Roh Park, Daejon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejon (KR)

(21) Appl. No.: 11/948,680

(22) Filed: Nov. 30, 2007

(30) Foreign Application Priority Data
Dec. 4, 2006 (KR) 10-2006-0121272
Oct. 5, 2007 (KR) 10-2007-0100557

(51) Int. Cl. H04J 3/00

(52) U.S. Cl. 370/336

(57) ABSTRACT

Provided are an apparatus and method for managing a Medium Access Slot (MAS) in a Wireless Personal Area Network (WPAN). The apparatus includes a transmission data storage unit for storing a transmission beacon and transmission data; a transmission controller for reading and transferring the transmission beacon to a transmission beacon control signal, and reading the transmission data and transferring it at a corresponding MAS; a transmission beacon parser for parsing the transmission beacon; an MAS allocation unit for comparing the reservation information with queue allocation information of an allocation queue list to allocate MAS; and a superframe controller for generating the transmission beacon control signal, and generating the data transmission/reception control signal at the start time of the MAS allocated by the MAS allocation unit.

### CROSS-REFERENCE(S) TO RELATED APPLICATIONS

The present invention claims priority of Korean Patent Application Nos. 10-2006-0121272 and 10-2007-0100557, filed on Dec. 4, 2006 and Oct. 5, 2007, respectively, which are incorporated herein by reference.

### BACKGROUND OF THE INVENTION

1. Field of the Invention

The present invention relates to an apparatus and method for managing a Medium Access Slot (MAS) in a Wireless Personal Area Network (WPAN); and, more particularly, to an apparatus and method for managing a beacon interval and all MAS information in a superframe within a shorter time period in hardware by parsing reservation information of transmission beacon for each superframe in a distributed WPAN.

This work was supported by the IT R&D program for MIC/IITA [2006-S-071-01, “Development of UWB Solution for High Speed Multimedia Transmission”].

2. Description of Related Art

It is known that WPAN is a network that operates within the area of about 10m and a distributed network is a network in which respective devices are not managed by one of them but share/manage a medium access control.

In the WPAN, beacon transmission/reception and data transmission/reception are made for each superframe. Especially, for Multi Band Orthogonal frequency division modulation Alliance Medium Access Control (MBOA MAC), one superframe is divided into multiple zones, each being divided into multiple MASs, where data transmission/reception is made in the unit of MAS. Here, the concept of MAS is similar to that of time slot.

FIG. 1 is a view illustrating superframes used in MAC of a conventional MBOA scheme.

Referring to FIG. 1, one superframe 101 is divided into 16 zones ranging zone 0 to zone 15. Among these zones, the first zone, i.e., the zone 0, includes a beacon transmission/reception interval and 16 MAS zones ranging MAS 0 to MAS 15 and the remaining zones ranging zone 1 to zone 15 include 16 MAS zones ranging MAS 0 to MAS 15.

Since one or more MASs are used for reservation of this MAS unit, there is a need for a system that requires a real-time process in order to handle reservation and management method of MAS unit at the time of high speed transmission/reception.

Generally, in the MBOA MAC, when data transmission/reception is ended at one MAS and data are transmitted/received with other devices at a next MAS, it is required that data should be taken and transmitted from a transmission data queue of region other than the previous MAS.

At this time, a transmission/reception method and a data queue need to be known and processed by new MAS information within a short time period of 10 to 20 μs. However, if MASs are managed by a conventional software method which finds out the end of MAS within a current superframe by using a timer in a system and exchanges it with the new MAS information, there may be a case where any frame cannot be transmitted within a given time period due to CPU occupation status, interrupt process delay time, or a transmission delay on a data bus. This leads to the deterioration in the entire transmission/reception performance and makes, in serious cases, data transmission/reception itself impossible.

### SUMMARY OF THE INVENTION

An embodiment of the present invention is directed to providing an apparatus and method for managing MAS in a WPAN, which manage a beacon interval and all MAS information in a superframe within a shorter time period in hardware by parsing reservation information of transmission beacon for each superframe in a distributed WPAN.

In other words, the present invention is to provide an apparatus and method for managing MAS in a WPAN, which read a transmission beacon from a transmission data queue at the start time of a superframe, detect reservation information and compare it with queue allocation information of an allocation queue list to allocate MAS if there is any allocated queue in the reservation information, and read transmission data at the start time of the allocated MAS and transmit it at the corresponding MAS.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

In accordance with one aspect of the present invention, there is provided an apparatus for managing a Medium Access Slot (MAS) in a Wireless Personal Area Network (WPAN), including: a transmission data storage unit for storing a transmission beacon and transmission data; a transmission controller for reading and transferring the transmission beacon stored in the transmission data storage unit in response to a transmission beacon control signal, and reading the transmission data stored in the transmission data storage unit and transferring it at a corresponding MAS in response to a data transmission/reception control signal; a transmission beacon parser for parsing the transmission beacon from the transmission controller to detect reservation information; an MAS allocation unit for comparing the reservation information from the transmission beacon parser with queue allocation information of an allocation queue list to allocate MAS if there is an allocated queue in the reservation information; and a superframe controller for generating the transmission beacon control signal at the start time of a superframe, and generating the data transmission/reception control signal at the start time of the MAS allocated by the MAS allocation unit to transfer the generated data transmission/reception control signal to the transmission controller.

In accordance with another aspect of the present invention, there is provided a method for managing MAS in a WPAN, including the steps of: at a transmission controller, reading a transmission beacon from a transmission data storage unit in response to a transmission beacon control signal provided at the start time of a superframe, and reading the transmission data stored in the transmission data storage unit and transferring it at a corresponding MAS in response to a data transmission/reception control signal; at a transmission beacon parser, parsing the transmission beacon to detect reservation information; at an MAS allocation unit, comparing the detected reservation information with queue allocation information of an allocation queue list to allocate MAS if there is an allocated queue in the reservation information; at a superframe controller, generating a data transmission/reception control signal at the start time of the allocated MAS; and at the transmission controller, reading transmission data in response to a data transmission/reception control signal and transmitting the transmission data at a corresponding MAS.

### BRIEF DESCRIPTION OF THE DRAWINGS

FIG. 1 is a view illustrating a superframe used in Medium Access Control (MAC) of a conventional Multi Band Orthogonal frequency division modulation Alliance (MBOA) method.

FIG. 2 is a view showing an example of a transmission beacon frame used in the present invention.

FIG. 3 is a block diagram illustrating the configuration of an apparatus for managing MAS in WPAN in accordance with an embodiment of the present invention.

FIG. 4 is a view illustrating one example of a transmission data queue and allocation queue list of the apparatus for managing MAS in accordance with an embodiment of the present invention.

FIG. 5 is a detailed diagram of the MAS allocation unit of the apparatus for managing MAS in accordance with an embodiment of the present invention.

FIG. 6 is a detailed circuit diagram of the queue comparator included in the MAS allocation unit of the apparatus for managing MAS in accordance with an embodiment of the present invention.

FIG. 7 is a flowchart illustrating a process of MAS allocation in the MAS allocation unit of the apparatus for managing MAS in accordance with an embodiment of the present invention.

FIG. 8 is a view showing the relationship between the MAS bitmap value and successive MAS counter value in accordance with an embodiment of the present invention.

FIG. 9 is a detailed view of the MAS information list in the superframe controller of the apparatus for managing MAS in accordance with an embodiment of the present invention.

FIG. 10 is a detailed block diagram of the superframe controller of the apparatus for managing MAS in accordance with an embodiment of the present invention.

FIG. 11 is a flowchart illustrating a process of managing MAS in the superframe controller of the apparatus for managing MAS in accordance with an embodiment of the present invention.

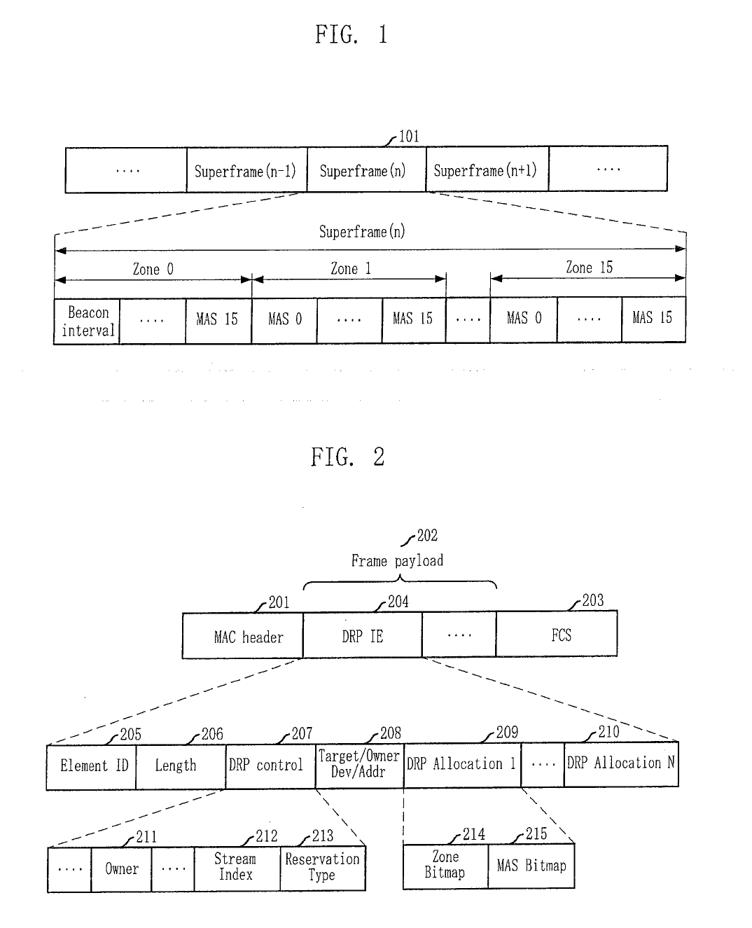

### DESCRIPTION OF SPECIFIC EMBODIMENTS

The advantages, features and aspects of the invention will become apparent from the following description of the embodiments with reference to the accompanying drawings, which is set forth hereinafter, and thus, the present invention will easily be carried out by those skilled in the art. Further, in the following description, well-known arts will not be described in detail if it seems that they could obscure the invention in unnecessary detail. Hereinafter, preferred embodiments of the present invention will be set forth in detail with reference to the accompanying drawings.

The preferred embodiments of the present invention are will be explained based on “Distributed MAC Release 1.0” of MBOA.

FIG. 2 is a view showing an example of a transmission beacon frame used in the present invention.

Referring to FIG. 2, the transmission beacon frame used in the invention includes a frame header 201, a frame payload 202, and an FCS 203.

Here, the frame payload 202 includes a Distributed Reservation Protocol (DRP) Information Element (IE) 204, which is used in reservation of MAS.

At this time, the DRP IE 204 includes an element identifier (ID) filed 205 which is used to determine whether it is a required DRP IE among multiple IEs, a length field 206 representing the length of the DRP IE, a DRP control field 207 representing reservation DRP information, a target/owner Device Address (DevAddr) field 208 indicating the address of transmission or reception device, and a plurality of DRP allocation fields (209, 210) representing the entire MAS allocation information of the superframe.

The DRP control field 207 includes an owner field 211 used in MAS allocation, a stream index field 212 and a reservation type field 213, and the DRP allocation field 209 includes a zone bitmap field 214 representing the location of MAS allocated within a superframe and an MAS bitmap field 215.

FIG. 3 is a block diagram illustrating the configuration of an apparatus for managing MAS in a WPAN in accordance with an embodiment of the present invention.

Referring to FIG. 3, the inventive apparatus for managing MAS in a WPAN includes a transmission data queue 301 for storing a transmission beacon and transmission data, a transmission controller 302 for reading the transmission beacon stored in the transmission data queue 301 and transferring it to a transmission beacon parser 303 in response to a control signal from a superframe controller 305 or reading the transmission data and transmitting it at a corresponding MAS, the transmission beacon parser 303 for parsing a DRP IE field of the transmission beacon from the transmission controller 302 to detect reservation information, an MAS allocation unit 304 for comparing the reservation information detected from the transmission beacon parser 303 with queue allocation information of an allocation queue list 306 to allocate MAS if there is any allocated queue in the reservation information, and a superframe controller 305 for generating a transmission beacon control signal at the start time of a superframe and generating a data transmission/reception control signal at the start time of MAS allocated by the MAS allocation unit 304 to deliver it to the transmission controller 302.

When the transmission beacon parser 303 receives a plurality of transmission beacons from the transmission controller 302, it sequentially parses a DRP IE of each transmission beacon to detect reservation information and then forward it to the MAS allocation unit 304. Then, the MAS allocation unit 304 sequentially allocates MAS if there is any allocated queue in the reservation information provided from the transmission beacon parser 303.

A method for managing MAS in WPAN in accordance with another preferred embodiment of the present invention will be described in detail.

First, a transmission beacon and transmission data are stored.

Next, the transmission beacon is read out from the transmission data queue 301 and then delivered to the transmission beacon parser 303 in response to a control signal transferred from the superframe controller 305 at the start time of a superframe.

Subsequently, the transmission beacon parser 303 parses a DRP IE field of the transmission beacon applied thereto to detect reservation information.

After that, the MAS allocation unit 304 compares the detected reservation information with queue allocation information of the allocation queue list 306 to allocate MAS if there is any allocated queue in the reservation information.

Next, the superframe controller 305 generates a data transmission/reception control signal at the start time of the allocated MAS and then transfers the same to the transmission controller 302.

Then, the transmission data is read out in response to the control signal from the transmission controller 302 and then sent at a corresponding MAS.

Meanwhile, in MAC software, the device address 208 and the stream index 212 which are allocated to a corresponding stream whenever a DRP stream where the reservation type 213 is ‘Hard’ is generated, and an allocated queue address on the transmission data queue 301 8 is set in the allocation queue list 306 of the MAC hardware through a register and this information is kept until the DRP stream is disappeared. At this time, the generated DRP stream is generally kept for multiple superframes.

Further, if the reservation type 213 is ‘Soft’ or ‘Prioritized Contention Access (PCA)’, a separate DRP queue is not used but an allocated queue is commonly used by Access Category (AC).

In one example, the reservation type 213 in the DRP IE 204 of MBOA MAC comes under one of various types given in the following list.

TABLE 1

| Value | Reservation Type |
|---|---|
| 0 | Alien BP |
| 1 | Hard |
| 2 | Soft |
| 3 | Private |
| 4 | PCA |
| 5-7 | Reserved |

where if the reservation type 213 is ‘Alien’ or ‘Reserved’, a transmission data queue is not allocated, but if it is ‘Private’, a queue is allocated according to the rule decided separately by manufacturers.

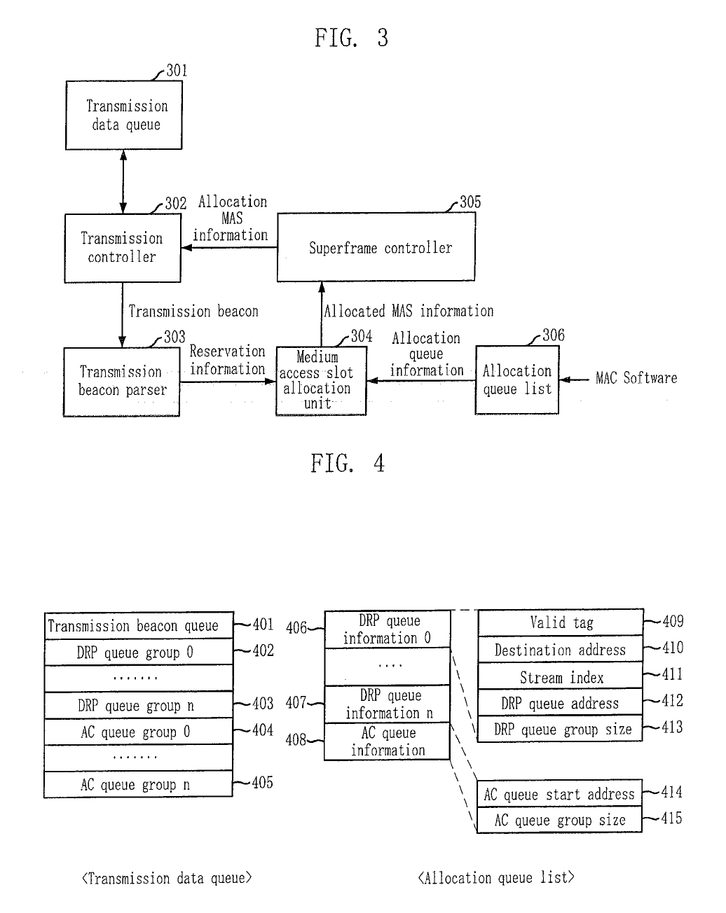

FIG. 4 is a view illustrating one example of the transmission data queue and the allocation queue list of the apparatus for managing MAS in accordance with an embodiment of the present invention.

First, the transmission data queue 301 includes one transmission beacon queue 401, a plurality of DRP queue groups 402 and 403, and a plurality of AC queue groups 404 and 405.

The transmission beacon queue 401 stores a beacon to be transmitted, i.e., a transmission beacon, at a corresponding superframe before the start time of the superframe, and the transmission beacon parser 303 reads and parses it in the order of MAC header and payload at the start time of the superframe.

One DRP queue group is a group of queue capable of storing multiple data frames, and is used when the reservation type 213 is ‘Hard’. The AC queue group is also a group of queue capable of storing multiple data frames, and is used when the reservation type 213 is ‘Soft’ or ‘PCA’.

Next, the allocation queue list 306 is divided into DRP queue information lists 406 and 407 and an AC queue information list 408.

The DRP queue information lists 406 and 407 correspond to DRP queue group information of the transmission data queue 301, and include a valid tag 409 indicating whether corresponding DRP queue information is valid, a destination address 410, which is a reception device address, a stream index 411, a DRP queue group's address 412, and a DRP queue group's size 413.

In general, since one reception device receives a plurality of streams each having a different stream index 411, one DRP queue group is decided by a combination of the inherent recipient address 410 and the stream index 411.

Further, the AC queue group is used when the reservation type 213 is ‘Soft’ or ‘PCA’, and in this case, all AC queue groups can be used, unlike the method of allocating DRP queue group, and thus, only the start address of AC queue 414 and the size of the AC queue group 415 that can be generated by the transmission device are provided.

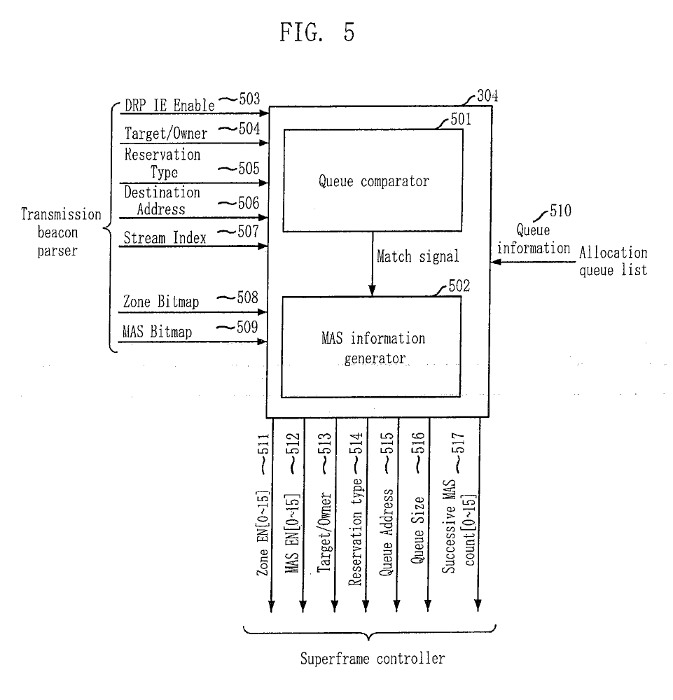

FIG. 5 is a detailed diagram of the MAS allocation unit of the apparatus for managing MAS in accordance with an embodiment of the present invention.

Referring to FIG. 5, the MAS allocation unit 304 of the apparatus for managing MAS in accordance with an embodiment of the present invention includes a queue comparator 501 for comparing a DRP IE enable signal 503 from the transmission beacon parser 303 at the start time of a superframe, target/owner information 504 synchronized with the DRP IE enable signal 503, reservation type information 505, the recipient address information 506, stream index information 507, zone bitmap information 508 and MAS bitmap information 509 with queue allocation information of the allocated queue list 306 to transfer a match signal to an MAS information generator 502 if there is any allocated queue; and the MAS information generator 502 for generating a zone enable signal 511 and an MAS enable signal 512 with 16 bits 511 and an MAS enable signal 512 in response to the match signal from the queue comparator 501, and generating target/owner 513, reservation type 514, queue address 515, queue size 516 and successive MAS count 517 information which are synchronized with these signals, to transfer them to the superframe controller 305.

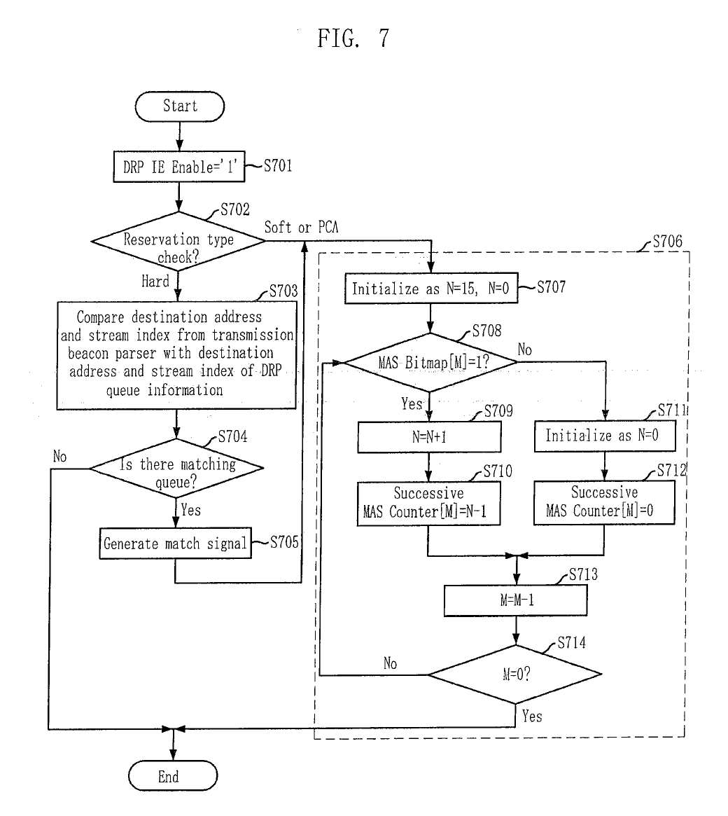

Here, the successive MAS count 517 is used to count residual time in order to continuously perform frame transmission upon change of MAS within the allocated MAS zone when there are several continuous allocated MASs. A detailed description therefore will be given with reference to FIG. 7.

This MAS allocation unit 304 allocates MAS whenever it receives the DRP enable signal 503 from the transmission beacon parser 303. At this time, the transmission beacon parser 303 sequentially generates, if the DRP IE of the transmission beacon is one or more, the DRP enable signal 503 every corresponding DRP IE.

Since this operation of parsing the beacon and allocating MAS is performed by hardware in real time, MAS can be automatically allocated only by the operation of transmitting beacon in terms of software, which is made in real time regardless of the CPU operation state.

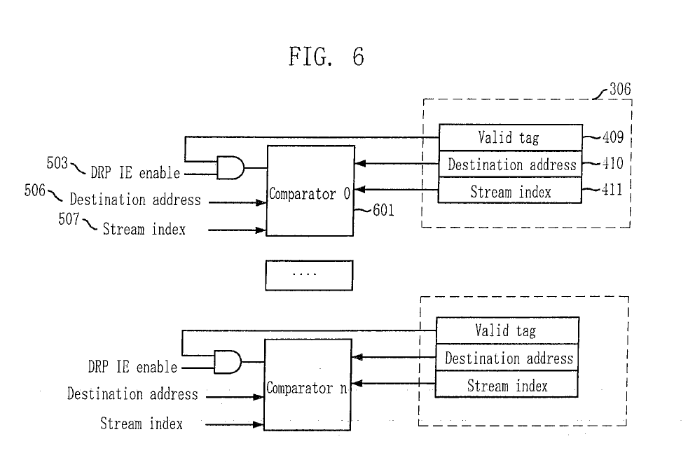

FIG. 6 is a detailed circuit diagram of the queue comparator in the MAS allocation unit of the apparatus for managing MAS in accordance with an embodiment of the present invention.

Referring to FIG. 6, a comparator 601 compares a destination recipient address 506 and a stream index 507 provided by the transmission beacon parser 303 with a destination recipient address 410 and a stream index 411 of allocation queue information of the allocation queue list 306 if the ‘reservation type’ is ‘Hard’ and the DRP IE enable signal 601 and the valid tag 409 of the DRP queue information are 1 at the same time.

If the DRP IE enable signal 601 and the valid tag 409 of the DRP queue information are 1 at the same time, this means that the DRP IE enable signal 601 is inputted and valid, when considering that if the DRP IE enable signal 601 is inputted, it recognizes as 1 and, if not, recognizes as 0, and if the DRP queue information is valid, it recognizes 1 and if not, it recognizes as 0.

Further, the comparator 601 is provided to correspond to the number of DRP queue information lists of the allocation queue list 306. Since the moment when the DRP IE enable signal 503 is 1 is very short, which is generally several dozens of ns, all comparisons are processed in parallel by a hardware method.

FIG. 7 is a flowchart illustrating a process of MAS allocation in the MAS allocation unit of the apparatus for managing MAS in accordance with an embodiment of the present invention.

When the DRP IE enable signal 503 is received from the transmission beacon parser 303 in step S701, the process checks a reservation type 505 in step S702.

As result of checking in step S702, if the reservation type 505 is ‘Hard’, the process compares the destination address 506 and the stream index 507 provided by the transmission beacon parser 303 with the destination address 410 and the stream index 411 of the DRP queue information to generate a match signal if there is a matching queue in steps S703 and S704. The MAS information generator 502 generates the successive MAS count 517 in response to the match signal in step S706.

As result of checking in step S702, if the reservation type 505 is ‘Soft’ or ‘PCA’, since the process does not require the comparison of the recipient address and the stream index, the process immediately generates the successive MAS counter 517 in step S706.

The following is a more detailed description for step S706.

The process initializes M denoting a total number of MASs to 15 and N indicating the actual value of the successive counter 517 to 0 in step S707.

Thereafter, the process checks whether the MAS bitmap (M) value is 1 in step S708.

As result of checking in step S708, if the MAS bitmap (M) value is 1, the process increases N by 1 and then subtracts 1 from N for storing the result as the successive MAS counter 517 in steps S709 and S710. At this time, the value of the successive MAS counter 517 is 0 but the value of N itself is 1.

As result of checking in step S708, if the MAS bitmap (M) value is not 1, the process initializes N to 0 and then stores 0 as the value of the successive MAS counter 517 in steps S711 and S712.

In next steps S713 and S714, the process subtracts M by 1 and checks whether M is 0. If M is not 0, the process returns to step S708 and if it is 0, the process is ended.

As a result, the process sets the value of the successive MAS counter 517 to the value which is obtained by subtracting 1 from N if the MAS bitmap (M) value provided by the transmission beacon parser 303 is 1 until M becomes 0 while subtracting the M value, in a manner that the value of the successive MAS counter 517 is set by interpreting the MAS bitmap 509 in reverse order.

Thus, if the MAS bitmap 509 is continuously 1, the value of the successive MAS counter 517 is increased in reverse order of the bitmap.

If the continuous 1 on the MAS bitmap 509 is ended, the process again initializes the successive MAS counter 517 to 0, and repeats the above process when 1 is continuously issued thereafter.

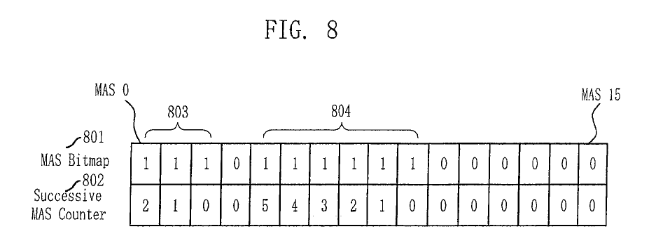

Details thereof will be provided with reference to FIG. 8.

FIG. 8 is a view showing the relationship between the MAS bitmap value and successive MAS counter value in accordance with an embodiment of the present invention.

Referring to FIG. 8, when 0 to 2^{nd} bits 803 of the MAS bitmap 801 and 4 to 9^{th} bits 804 are continuously set to 1, the corresponding successive MAS counter 802 value is set such that 0 to 2^{nd} values are 2, 1, 0 and 4 to 9^{th} values are 5, 4, 3, 2, 1.

By using the values so set, the process calculates, at the superframe controller 305, residual time at the start point of the corresponding MAS and transfers the result to the transmission controller 302. That is, the residual time is calculated as follows:

Residual time=(successive MAS counter+1)×MAS slot time Eq. (1)

where the MAS slot time is 256 μs in case of MBOA MAC.

For example, the residual time (MAS 0) at the start time of MAS 0 in FIG. 8 is calculated to be 768 μs ((2+1)×MAS slot time (256 μs)). That is, although MAS is changed to 0→2 for this time, the given stream is transmitted without interruption regardless of change of MAS.

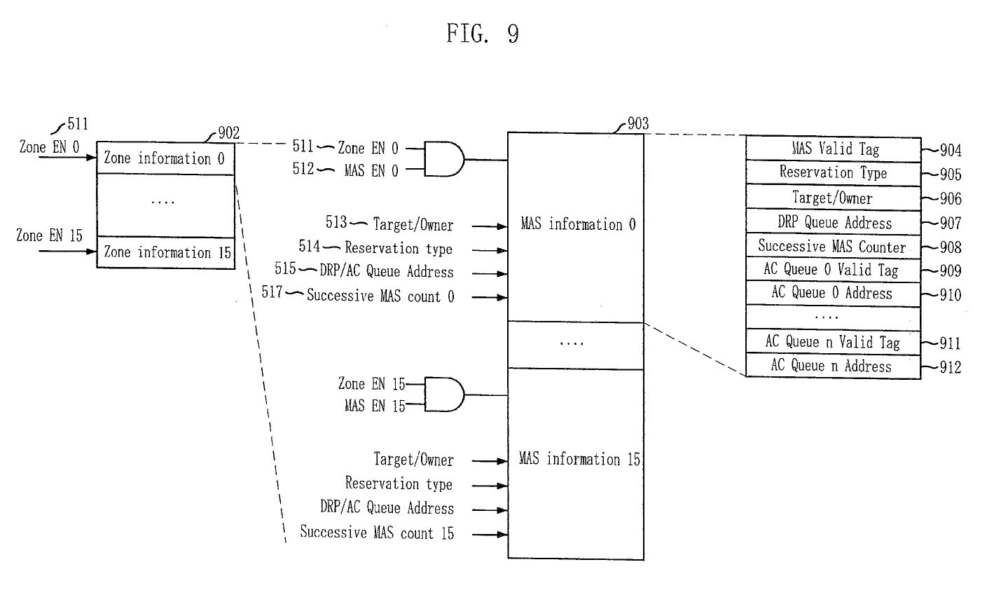

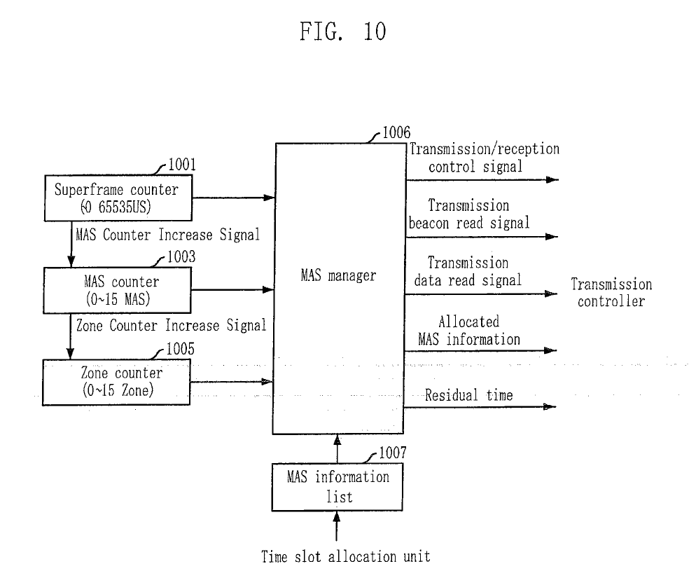

FIG. 9 is a detailed view of the MAS information list in the superframe controller of the apparatus for managing MAS in accordance with an embodiment of the present invention.

Referring to FIG. 9, 16 zones 902 are included in one superframe, and 16 MAS information 903 exist in each zone. Thus, there is a total of 256 MAS information.

The storage of each MAS information in one zone is done when the corresponding zone enable signal 511 and the MAS enable signal 512 are 1 at the same time. Further, each of 16 successive MAS counters 517 is assigned to and stored in the corresponding MAS information 903. The remaining signals 513 to 515 are commonly assigned to all MASs.

One MAS information 903 includes an MAS valid tag field 904 representing whether the corresponding MAS is valid, a reservation type field 905, a target/owner field 906 for deciding whether there is a transmission/reception of device, a DRP queue address field 907, a successive MAS counter field 908, AC queue valid tag fields 909 and 911, and AC queue address fields 910 and 912.

The entire MAS information list of superframe is structured by collecting these 256 MAS information.

FIG. 10 is a detailed block diagram of the superframe controller of the apparatus for managing MAS in accordance with an embodiment of the present invention.

Referring to FIG. 10, the superframe controller 305 of the apparatus for managing MAS in accordance with an embodiment of the present invention includes a superframe counter 1001 for counting while circulating from 0 to 65535 μs by 1 μs unit, an MAS counter 1003 for counting while circulating from 0 to 15 every 256 82 s when MAS changes, a zone counter 1005 for counting while circulating from 0 to 15 every 16 MASs when MAS changes, and an MAS manager 1006 for generating a transmission beacon control signal, e.g., transmission beacon read signal, at the start time of the superframe and a data transmission/reception control signal, e.g., transmission/reception (TX/RX) control signal, a transmission data read signal, allocated MAS information and residual time, at the start time of each MAS by using the count information from the superframe counter 1001, the MAS counter 1003 and the zone counter 1005, and an MAS information list 1007 and providing them to the transmission controller 302.

The superframe counter 1001 generates an MAS counter increase signal every 256 μs and inputs it to the MAS counter 1003, and the MAX counter 1003 produces a zone counter increase signal every 16 MASs and inputs it to the zone counter 1005.

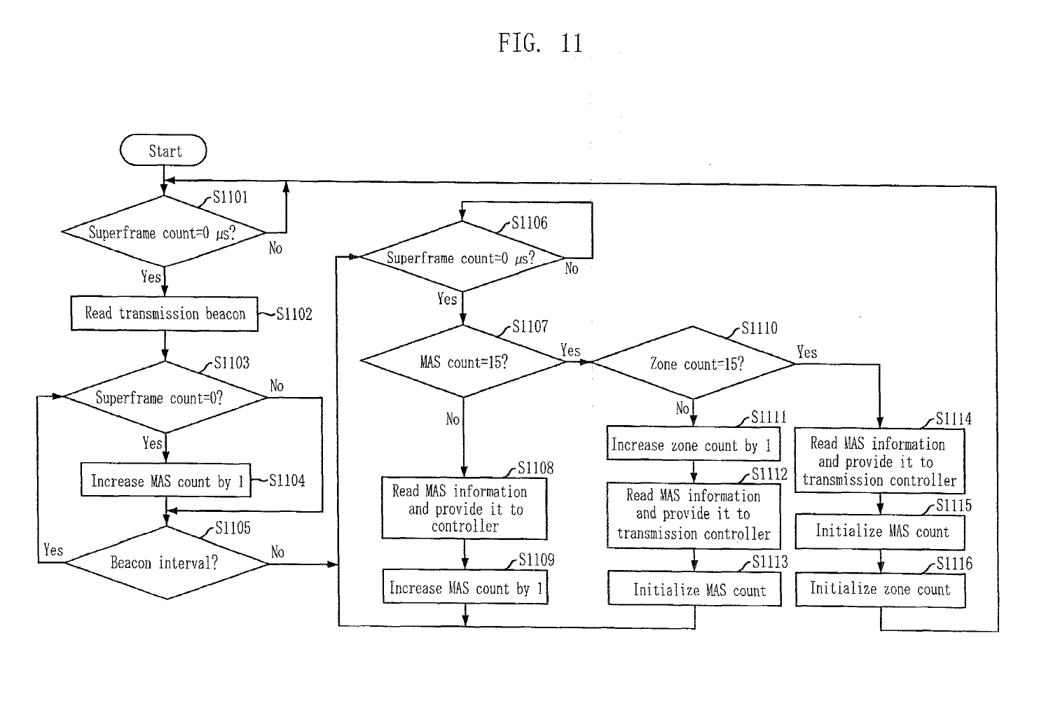

FIG. 11 is a flowchart illustrating a process of managing MAS in the superframe controller of the apparatus for managing MAS in accordance with an embodiment of the present invention.

When the count of superframe is 0 μs, i.e., at the start point of superframe, the process generates a transmission beacon read signal and allows the transmission controller 302 to read the transmission beacon in the transmission beacon queue 401 of the transmission data queue 301 in steps S1101 and S1102.

The process increases an MAS count by 1 every 256 μs in steps S1103 and S1104. That is, there exists the beacon transmission/reception zone at the start of superframe, and, in this case, only MAS count increases without transmitting MAS information.

When the beacon interval is ended in step S1105, the process reads the MAS information 903 at the start time of MAS until the MAS count becomes 15, and then provides it to the transmission controller 302 in steps S1106 to S1109.

At this time, if the MAS count is 15 and the zone count is not 15, the process increases the zone count, and reads the MAS information 903 and forwards it to the transmission controller 302, followed by initializing the MAS count, in steps S1110 to S1113.

If both the MAS count and the zone count are 15, this corresponds to the last MAS among all the MASs. In this case, the process reads the last MAS information and delivers it to the transmission controller 302, and initializes the MAS count and zone count to 0 in steps S1114 to S1116.

Thereafter, the process again performs the reading of he transmission beacon at the start of a next superframe.

This process is repeatedly carried out for every superframe.

On the other hand, the method of the invention as set forth above may be implemented by a computer program. Further, the codes and code segments constituting such program can readily be extracted from any computer programmer in the art. The above-written program is stored in a computer-readable storage medium, and is readable and executable by the computer, thereby the method of the invention. The storage medium includes all forms of storage media that can be read by the computer.

As described above, the present invention can effectively manage a beacon interval and all MAS information in a superframe within a shorter time period in hardware by parsing reservation information of transmission beacon for each superframe in a distributed WPAN.

In addition, the present invention can parse reservation information of transmission beacon for each superframe in a WPAN that requires a high speed real-time process and reserve and manage a beacon interval and all MAS information in a superframe within a shorter time period in hardware, thereby guaranteeing a real-time operation of a medium access control apparatus and preventing the lowering of performance regardless of system conditions of CPU and interrupt process.

While the present invention has been described with respect to the particular embodiments, it will be apparent to those skilled in the art that various changes and modifications may be made without departing from the spirit and scope of the invention as defined in the following claims.

What is claimed is:

1. An apparatus for managing a Medium Access Slot (MAS) in a Wireless Personal Area Network (WPAN), comprising:
a transmission data storage unit for storing a transmission beacon and transmission data;
a transmission controller for reading and transferring the transmission beacon stored in the transmission data storage unit in response to a transmission beacon control signal, and reading the transmission data stored in the transmission data storage unit and transferring it at a corresponding MAS in response to a data transmission/reception control signal;
a transmission beacon parser for parsing the transmission beacon from the transmission controller to detect reservation information;
an MAS allocation unit for comparing the reservation information from the transmission beacon parser with queue allocation information of an allocation queue list to allocate MAS if there is an allocated queue in the reservation information; and
a superframe controller for generating the transmission beacon control signal at the start time of a superframe, and generating the data transmission/reception control signal at the start time of the MAS allocated by the MAS allocation unit to transfer the generated data transmission/reception control signal to the transmission controller.

2. The apparatus of claim 1, wherein the MAS allocation unit includes:
a queue comparator for comparing the reservation information provided from the transmission beacon parser at the start time of a superframe with the queue allocation information of the allocation queue list to transfer a match signal if there is an allocated queue; and
an MAS information generator for generating MAS allocation information in response to the match signal from the queue comparator to deliver the MAS allocation information to the superframe controller.

3. The apparatus of claim 2, wherein the reservation information includes a Distributed Reservation Protocol (DRP) Information Element (IE) enable signal, and target or owner information, reservation type information, recipient address information, steam index information, zone bitmap information and MAS bitmap information which are synchronized with the DRP IE enable signal.

4. The apparatus of claim 3, wherein the MAS information generator generates a zone enable signal and an MAS enable signal with 16 bits, and generates target or owner, reservation type, queue address, queue size, and successive MAS count information which are synchronized with the generated signals.

5. The apparatus of claim 4, wherein the queue comparator includes a comparator for comparing a destination recipient address and a stream index from the transmission beacon parser with a destination recipient address and a stream index among the allocation queue information of the allocation queue list if the reservation type is ‘Hard’, the DRP IE enable signal is inputted, and a valid tag of the DRP queue information is valid information.

6. The apparatus of claim 5, wherein the comparator is provided to correspond to the number of the DRP queue information lists of the allocation queue list so that the comparing process is performed in parallel.

7. The apparatus of claim 1, wherein the superframe controller includes:
a superframe counter for counting while circulating from 0 to 65535 μs by 1 μs unit to generate an MAS counter increase signal every 256 μs and provide it to an MAS counter;
the MAS counter for counting while circulating from 0 to 15 in response to the MAS counter increase signal from the superframe counter to generate a zone counter increase signal every 16 MASs to provide it to a zone counter;
the zone counter for counting while circulating from 0 to 15 in response to the zone counter increase signal from the MAS counter; and
an MAS manager for generating the transmission beacon control signal at the start time of the superframe and the data transmission and reception control signal at the start time of each MAS by using the information counted by the superframe counter, the MAS counter and the zone counter, and MAS information list, and providing it to the transmission controller.

8. The apparatus of claim 7, wherein the transmission beacon control signal includes a transmission beacon read signal, and the data transmission/reception control signal includes a transmission/reception control signal, a transmission data read signal, allocated MAS information, and residual time.

9. The apparatus of claim 8, wherein the residual time is calculated by:
Residual time=(successive MAS counter+1)×MAS slot time
where the successive MAS counter denotes the number of allocated MASs, and the MAS slot time is 256 μs in case of Multi Band Orthogonal frequency division modulation Alliance Medium Access Control (MBOA MAC).

10. The apparatus of claim 9, wherein the MAS information includes an MAS valid tag field indicating whether a corresponding MAS is valid, a reservation type field, a target or owner field for determining whether a device is in a transmission/reception state, a DRP queue address field, a successive MAS counter field, a plurality of Access Category (AC) queue valid tag fields representing whether an AC queue is used at the corresponding MAS, and a plurality of AC queue address fields.

11. The apparatus of claim 1, wherein the transmission data storage unit includes:
a transmission beacon queue for storing a beacon to be transmitted, which is a transmission beacon, from the corresponding superframe before the start time of the superframe;
a plurality of DRP queue groups for storing a plurality of data frames if the reservation type is ‘Hard’; and
a plurality of AC queue groups for storing a plurality of data frames if the reservation type is ‘Soft’ or ‘Prioritized Contention Access (PCA)’.

12. The apparatus of claim 11, wherein the allocation queue list includes the DRP queue information list and the AC queue information list,
the DRP queue information list corresponding to the DRP queue group information of the transmission data storage unit and including a valid tag indicating whether corresponding DRP queue information is valid, a destination address, which is a reception device address, a stream index, a DRP queue group's address, and a DRP queue group's size, and
the AC queue information list corresponding to the AC queue group information of the transmission data storage unit and including a start address of AC queue which can be generated by a transmission device and an AC queue group's size.

13. A method for managing a Medium Access Slot (MAS) in a Wireless Personal Area Network (WPAN), comprising the steps of:
at a transmission controller, reading a transmission beacon from a transmission data storage unit in response to a transmission beacon control signal provided at the start time of a superframe, and reading the transmission data stored in the transmission data storage unit and transferring it at a corresponding MAS in response to a data transmission/reception control signal;
at a transmission beacon parser, parsing the transmission beacon to detect reservation information;
at an MAS allocation unit, comparing the detected reservation information with queue allocation information of an allocation queue list to allocate MAS if there is an allocated queue in the reservation information;
at a superframe controller, generating a data transmission/reception control signal at the start time of the allocated MAS; and
at the transmission controller, reading transmission data in response to a data transmission/reception control signal and transmitting the transmission data at a corresponding MAS.

14. The method of claim 13, wherein the step of comparing the detected reservation information with queue allocation information of an allocation queue list to allocate MAS includes the steps of:
checking a reservation type when a DRP IE enable signal is received from the transmission beacon parser; and
if it is checked that the reservation is ‘Hard’, comparing a destination address and a stream index provided by the transmission beacon parser with a destination address and a stream index of DRP queue information to generate a successive MAS counter if there is a matching queue, and if it is checked that the reservation is ‘Soft’ or ‘PCA’, generating a successive MAS counter without a separate comparison process.

15. The method of claim 14, wherein the step of generating a successive MAS counter includes the steps of:
initializing M representing a total number of MASs to 15, and N which is the actual value of the successive MAS counter to 0;
checking whether the MAS bitmap [M (where a total number of MASs is 15)] value is 1;
if it is checked that the MAS bitmap value is 1, increasing N by 1 and storing a value which is obtained by subtracting 1 from N as the successive MAS counter value;
if it is checked that the MAS bitmap value is not 1, initializing N to 0 and storing 0 as the successive MAS counter value; and
checking whether M is 0 after subtracting N by 1, and if it is not 0, repeatedly performing the steps of increasing N by 1 and storing the value as the successive MAS counter value and initializing N to 0 and storing 0 as the successive MAS counter value.

16. The method of claim 14, wherein the reservation information includes a DRP IE enable signal, and target or owner information, reservation type information, recipient address information, steam index information, zone bitmap information and MAS bitmap information which are synchronized with the DRP IE enable signal.

17. The method of claim 16, wherein in the step of allocating MAS, a zone enable signal and an MAS enable signal with 16 bits are generated, and target or owner, reservation type, queue address, queue size, and successive MAS count information which are synchronized with the generated signals are generated.

18. The method of claim 17, wherein the step of allocating MAS includes the step of:
comparing a destination recipient address and a stream index from the step of parsing the transmission beacon to detect reservation information with a destination recipient address and a stream index among the allocation queue information of the allocation queue list if the reservation type is ‘Hard’, the DRP IE enable signal is inputted, and a valid tag of the DRP queue information is valid information.

19. The method of claim 18, wherein the step of comparing the destination recipient address and the stream index is provided to correspond to the number of the DRP queue information lists of the allocation queue list so that the comparing process is performed in parallel.

20. The method of claim 13, wherein the step of generating the data transmission/reception control signal includes the steps of:
at a superframe counter, generating a transmission beacon read signal at 0 μs;
increasing an MAS count every 256 μs and a zone count every 16 MAS counts;
when a beacon interval is ended, reading MAS information at the start point of MAS and providing it to the transmission controller until the MAS count is 15;
if the MAS count is 15 and the zone count is not 15, increasing the zone count, reading the MAS information, providing it to the transmission controller, and initializing the MAS count; and
if both the MAS count and the zone count are 15, reading the last MAS information, providing it to the transmission controller, and initializing the MAS count and the zone count to 0 since it is the last MAS among all the MASs.

21. The method of claim 20, wherein the transmission beacon control signal includes a transmission beacon read signal, and the data transmission/reception control signal includes a transmission/reception control signal, a transmission data read signal, allocated MAS information, and residual time.

22. The method of claim 21, wherein the step of generating the data transmission/reception control signal calculates the residual time as follows:
Residual time=(successive MAS counter+1)×MAS slot time
where the successive MAS counter denotes the number of allocated MASs, and the MAS slot time is 256 μs in case of MBOA MAC.

23. The method of claim 22, wherein the MAS information includes an MAS valid tag field indicating whether a corresponding MAS is valid, a reservation type field, a target or owner field for determining whether a device is in a transmission/reception state, a DRP queue address field, a successive MAS counter field, a plurality of AC queue valid tag fields representing whether an AC queue is used at the corresponding MAS, and a plurality of AC queue address fields.

24. The method of claim 20, wherein the allocation queue list includes the DRP queue information list and the AC queue information list,
the DRP queue information list corresponding to the DRP queue group information of the transmission data storage unit and including a valid tag indicating whether corresponding DRP queue information is valid, a destination address (reception device address), a stream index, a DRP queue group's address, and a DRP queue group's size, and
the AC queue information list corresponding to the AC queue group information of the transmission data storage unit and including a start address of AC queue which can be generated by a transmission device and an AC queue group's size.
